(19) United States
(12) Patent Application Publication
(10) Pub. No.: US 2009/0097857 A1
(43) Pub. Date: Apr. 16, 2009

(54) DOWNHOLE OPTICAL COMMUNICATION SYSTEM AND METHOD

(75) Inventor: Carl W. Stoesz, Houston, TX (US)

Correspondence Address: CANTOR COLBURN, LLP, 20 Church Street, 22nd Floor, Hartford, CT, 06103, US

(73) Assignee: BAKER HUGHES INCORPORATED, Houston, TX (US)

(21) Appl. No.: 11/871,395

(22) Filed: Oct. 12, 2007

(51) Int. Cl. H04B 10/00

(52) U.S. Cl. 398/135; 398/140

(57) ABSTRACT

Disclosed herein is a downhole optical communication system. The system includes, at least one optical transmitter and at least one optical receiver. The at least one optical receiver is in operable communication with the at least one optical transmitter such that wellbore fluid is passable between the at least one optical transmitter and the at least one optical receiver, the at least one optical receiver is receptive of light emitted from the at least one optical transmitter and information encoded therein.

### BACKGROUND OF THE INVENTION

It is common in the downhole hydrocarbon recovery industry to communicate information from the surface to downhole locations and from downhole locations to the surface. Such communication has been possible for a very long time, it was just the speed of the communication that was a problem (a few bits per second) and that limited what information they tried to send uphole. Such communication can use optical signals, such as laser light, for example, to carry encoded communication information over optical fibers. Alternately, electrical signals communicate information over electric lines such as wirelines. These systems typically use a continuous optical fiber or wireline to connect between the surface and a downhole apparatus with which the operator wishes to communicate. Systems that do not have a continuous optical fiber or wireline often use connectors to couple together separate pieces of optical fiber or wireline. Such connectors need the ends of separate pieces of optical fiber or wireline be located approximate one another with tight dimensional tolerances. Maintaining these tight dimensional tolerances can be difficult in the conditions encountered in a downhole environment.

### BRIEF DESCRIPTION OF THE INVENTION

Disclosed herein is a downhole optical communication system. The system includes, at least one optical transmitter and at least one optical receiver. The at least one optical receiver is in operable communication with the at least one optical transmitter such that wellbore fluid is passable between the at least one optical transmitter and the at least one optical receiver, the at least one optical receiver is receptive of light emitted from the at least one optical transmitter and information encoded therein.

Further disclosed herein is a downhole optical communication system. The system includes, at least one light producing transducer and at least one light receiving transducer in operable communication with the at least one light producing transducer such that wellbore fluid is passable between the at least one light producing transducer and the at least one light receiving transducer. The at least one light receiving transducer is receptive of light emitted from the at least one light producing transducer and information encoded therein.

Further disclosed herein is a downhole optical communication system. The system includes, at least one first optical transceiver and at least one second optical transceiver in operable communication with the at least one first optical transceiver such that wellbore fluid is passable between the at least one first optical transceiver and the at least one second optical transceiver. The at least one first optical transceiver is receptive of light emitted from the at least one second optical transceiver and information encoded therein, and the at least one second optical transceiver is receptive of light emitted from the at least one first optical transceiver and information encoded therein.

Further disclosed herein is a downhole communication method. The method includes, transmitting optical signals having communication information encoded therein and receiving the optical signals and communication information encoded therein from the transmitting, the receiving is displaced from the transmitting by a dimension fillable with downhole fluid.

### BRIEF DESCRIPTION OF THE DRAWINGS

The following descriptions should not be considered limiting in any way. With reference to the accompanying drawings, like elements are numbered alike:

FIG. 1 depicts a downhole optical communication system disclosed herein;

FIG. 2 depicts an alternate downhole optical communication system disclosed herein;

FIG. 3 depicts an optical fiber transmitter/receiver usable in the communication system of FIG. 1; and

FIG. 4 depicts an alternate downhole optical communication system disclosed herein

### DETAILED DESCRIPTION OF THE INVENTION

A detailed description of one or more embodiments of the disclosed apparatus and method are presented herein by way of exemplification and not limitation with reference to the Figures.

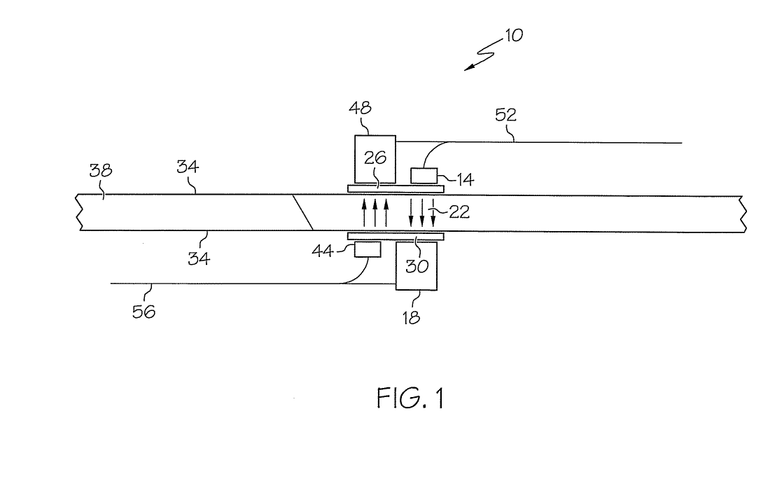

Referring to FIG. 1, an embodiment of the downhole optical communication system 10 disclosed herein is illustrated. The communication system 10 includes, a first optical transmitter 14 and a first optical receiver 18. Between the first optical transmitter 14 and the first optical receiver 18 is a cavity 22 that is open to wellbore fluids. In this embodiment, a window 26, transparent to wavelengths of light emitted by the transmitter 14, seals the transmitter 14 from fluid in the cavity 22. Similarly, a second window 30, also transparent to the wavelengths of light emitted by the transmitter 14, seals the receiver 18 from fluid in the cavity 22. It should be understood that throughout this disclosure the word light is defined to include all wavelengths of electromagnetic radiation and not just those within the visible spectrum. The windows 26, 30 are sealedly attached to walls 34 of a downhole member 38 such as a tubular, for example. The transmitter 14 transmits light towards the receiver 18. Light from the transmitter 14 travels through the window 26, the cavity 22 and the window 30 before it reaches the receiver 18. As such, the communication system 10 can efficiently convey communication information encoded in the light from the transmitter 14 to the receiver 18.

A second optical transmitter 44, in this embodiment, is coupled to the window 30 and a second optical receiver 49 is coupled to the window 26. As such, the second transmitter 44 is able to convey communication information to the second receiver 48 in substantially the same way that the transmitter 14 conveys information to the receiver 18. The addition of the second transmitter 44 and the second receiver 48 allows the communication system 10 to convey information in either direction across the cavity 22. It should be noted that the second transmitter 44 and the second receiver 48 could be coupled to windows other than the windows 26 and 30. It should be further noted that the transmitter 14 and the receiver 48 could be incorporated into a single transmitter/receiver, for example. Similarly, the receiver 18 and the transmitter 44 could also be incorporated into a single transmitter/receiver device.

The first transmitter 14 and the second receiver 48 are connected to a downhole fiber optic cable 52, in this embodiment, and the first receiver 18 and the second transmitter 44 are connected to an uphole fiber optic cable 56. The optic cable 52 can be connected to a downhole processor (not shown), for example, as are known in the industry for processing data downhole as well as receiving and transmitting communication information. The optic cable 56 can be connected to a communication device (not shown), as is also known in the industry, located at the surface. Thus, the communication system 10 described above permits bi-directional communication between the surface and a downhole processor via the fiber optic cables 52, 56, the transmitters 14, 44 and the receivers 18, 48.

Transmitting and receiving communication information optically across the cavity 22, as provided by the transmitter 14, 44 to receiver 44, 48 arrangements, disclosed herein, permits variation in a dimensional coupling between the transmitters 14, 44 and the receivers 18, 48. Such variation can be useful at transmitter to receiver interfaces where one downhole member, such as a member of a drill string, for example, is connected with another downhole member, for example. Additionally, the communication system 10 may be incorporated into connectable ends of downhole members such that the communication link is automatically established upon connection of one downhole member to another downhole member. In such case, there could be a plurality of communication systems 10 used along a single tool string to simplify and expedite connecting one member of a tool string with the next.

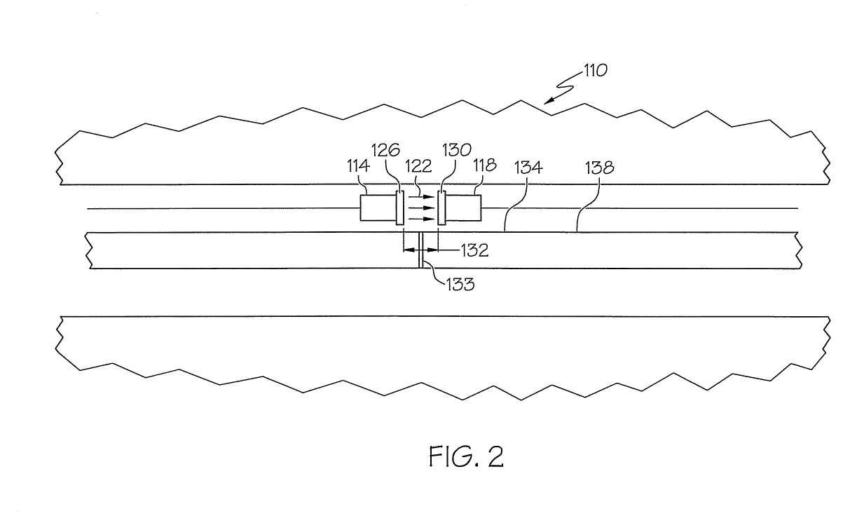

Referring to FIG. 2, an alternate embodiment of the communication system 110 disclosed herein is illustrated. The communication system 110 includes, an optical transmitter 114, an optical receiver 118 and a cavity 122 positioned between the transmitter 114 and the receiver 118 that can be filled with downhole fluid. A window 126, transparent to a wavelength of light that is emitted by the transmitter 114, separates the transmitter 114 from the cavity 122. Similarly, a second window 130, also transparent to the wavelength of light being emitted by the transmitter 114, separates the receiver 118 from the cavity 122. The windows 126, 130 are sealedly fixed to walls 134 of a downhole member 138 such as a tubular, for example. The transmitter 114 is coupled to the window 126 so that light emitted from the transmitter 114 is efficiently directed into the cavity 122. The receiver 118, is coupled to the window 130 so that the receiver 118, through the window 130, efficiently receives light from the cavity 122. As such, the communication system 110 can efficiently convey communication information encoded in the light from the transmitter 114 to the receiver 118.

The communication system 110 can accommodate variations in a dimension 132 between the windows 126 and 130. As such, the communication system 110 can be used to communicate across an expansion joint 133, for example, wherein the dimension 132 varies with expansion and contraction of the downhole member 138 to which the transmitter 114 and the receiver 118 are attached.

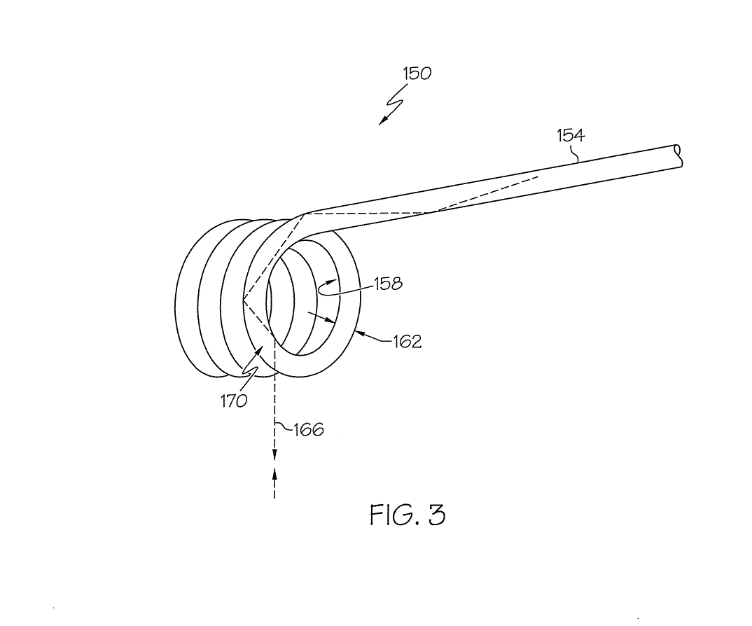

Referring to FIG. 3, an embodiment of an optical transmitter/receiver 150 is illustrated. The optical transmitter/receiver 150 could be used for any or all of the transmitters 14, 44, 114, as well as the receivers 18, 48, 118, disclosed above. The transmitter/receiver 150 of this embodiment includes an optical fiber 154 that is formed into a helical coil. A bend radius 158 of the coil is set to control how much light escapes the fiber 154, in the case wherein the coil is a transmitter, and how much light enters into the coil, in the case wherein the coil is a receiver. Besides the bend radius 158, several other factors affect the amount of light retained or captured by the coil, including; the material from which the fiber 154 is constructed, thickness 162 of the fiber 154 and properties of a fluid within which the fiber 154 is located, to name a few. These factors affect angles at which light 166 contacts surfaces 170 defined by walls of the fiber 154. Additionally, these factors influence what percentage of the light 166 is reflected from such surfaces 170 and what percentage of the light 166 passes through such surfaces 170. For example, if the bend radius 158 is small, a high percentage of the light 166 will escape the fiber 154 since angles of incidence will be smaller than if the bend radius 158 were large. When the bend radius 158 is large, as is the case when the fiber 154 is straight, such that the bend radius 158 is effectively infinite, the incidence angles become very large thereby retaining nearly all of the light within the fiber 154 through internal reflection from the surfaces 170. The ability of the fiber 154 to capture light that impinges the surfaces 170 externally is similarly effected by the factors mentioned above. As such, a fiber 154 with a smaller bend radius 158 will capture a higher percentage of light 166 that contacts the fiber 154 than a fiber 154 with a large bend radius 158. The foregoing coiled fiber 154, therefore, acts as both a transmitter to emit light traveling within the fiber 154, as well as a receiver to capture light entering the fiber 154.

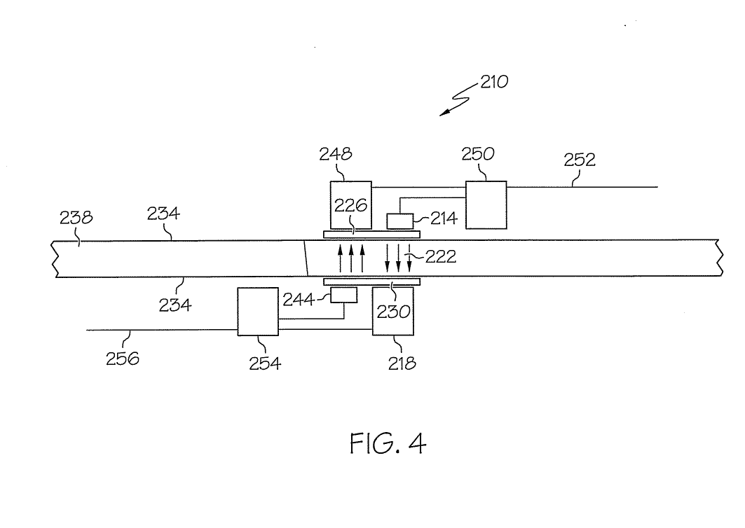

Referring to FIG. 4 an alternate embodiment, of the downhole communication system 210, is illustrated. The communication system 210 includes, a first light producing transducer 214, a first light receiving transducer 218 and a cavity 222 positioned between the producing transducer 214 and the receiving transducer 218 that can be filled with downhole fluid. The light producing transducer 214 can be a light emitting diode “LED,” laser diode, or other transducer capable of converting electrical energy into light energy, for example. Similarly, the light receiving transducer 218 can be a photo diode, or other transducer capable of converting light energy into electrical energy. A window 226, transparent to a wavelength of light that is emitted by the producing transducer 214, separates the producing transducer 214 from the cavity 222. Similarly, a second window 230, also transparent to the wavelength of light being emitted by the producing transducer 214, separates the receiving transducer 218 from the cavity 222. The windows 226, 230 are sealedly fixed to walls 234 of a downhole member 238 such as a tubular, for example. The producing transducer 214 is coupled to the window 226 so that light emitted from the producing transducer 214 is efficiently directed into the cavity 222. Some of the light transmitted into the cavity 222 is received by the receiving transducer 218, which is coupled to the window 230 so that the receiving transducer 218, through the window 230, efficiently receives light from the cavity 222. As such, the communication system 210 can efficiently convey communication information encoded in the light from the producing transducer 214 to the receiving transducer 218.

A second light producing transducer 244, in this embodiment, is coupled to the window 230 and a second light receiving transducer 248 is coupled to the window 226. As such, the second producing transducer 244 is able to convey communication information to the second receiving transducer 248 in much the same way that the first light producing transducer 214 conveys information to the first light receiving transducer 218. The addition of the second producing transducer 244 and the second receiving transducer 248 allows the communication system 10 to convey information in either direction through the cavity 222. It should be noted that the second producing transducer 244 and the second receiving transducer 248 could be coupled to windows other than the windows 226 and 230.

The first light producing transducer 214 and the second light receiving transducer 248, of this embodiment, are connected to a transceiver 250 that is connected to downhole directed wireline 252. Similarly, the receiving transducer 218 and the second producing transducer 244 are connected to transceiver 254 that is connected to an uphole directed wireline 256. Each of the transceivers 250 and 254 have circuitry (not shown) that can process both signals received from their respective receiving transducers as well as signals going to their respective producing transducers. The wireline 252 can be connected to a downhole processor (not shown), for example, as are known in the industry. Such a downhole processor can receive communication information from the transceiver 250 as well transmit communication information to the transceiver 250 over the wireline 252. The wireline 256 can be connected to a communication device (not shown), as is also known in the industry, located at the surface, for example. Such a communication device can receive communication information from the transceiver 254 and transmit communication information to the transceiver 254 over the wireline 254. Thus, the communication system 210 described above allows bi-directional communication between the communication device at the surface and the downhole processor via the wirelines 252, 256, the transceivers 150, 254, the producing transducers 214, 244 and the receiving transducers 218, 248. It should be noted that alternate embodiments could have the light producing transducer 214, the light receiving transducer 248 incorporated into the transceiver 250. Similarly, the light producing transducer 244 and the light receiving transducer 218 could be incorporated into the transceiver 254.

Additionally, an optical amplifier such as an erbium doped fiber amplifier, for example, could be incorporated into any of the optical transmitters 14, 44, 114, 150 or optical receivers 18, 48, 118, 150 disclosed herein. Use of an optical amplifier could permit amplification of the optical signals without first converting them into electrical signals.

It should also be noted that it might be desirable for the communication systems 10, 110, 210 disclosed herein to use light with wavelengths greater than about 1300 nanometers “nm”. As light with wavelengths greater than about 1300 nm have been found to efficiently pass through hydrocarbons such as oil, for example, with little absorption of the light energy. Additionally, portions of the electromagnetic spectrum with such wavelengths have been designated for communication use. For example, the C Band, with wavelengths from 1530 to 1565 nm, and the L Band, with wavelengths from 1570 to 1610, are specifically used for wavelength division multiplexing (WDM) communication purposes. The WDM permits bi-directional communication with increased capacity through use of separate wavelengths to carry distinct signals. As such, the C band, the L band and WDM are good choices for use in embodiments herein. While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

What is claimed is:

1. A downhole optical communication system, comprising:
at least one optical transmitter; and
at least one optical receiver, the at least one optical receiver being in operable communication with the at least one optical transmitter such that wellbore fluid is passable between the at least one optical transmitter and the at least one optical receiver, the at least one optical receiver being receptive of light emitted from the at least one optical transmitter and information encoded therein.

2. The downhole optical communication system of claim 1, wherein at least one of the optical transmitter and the optical receiver is an optical fiber.

3. The downhole optical communication system of claim 1, wherein the at least one optical transmitter further comprises a light emitting diode.

4. The downhole optical communication system of claim 1, wherein the at least one optical transmitter further comprises a laser.

5. The downhole optical communication system of claim 4, wherein the laser is a laser diode.

6. The downhole optical communication system of claim 1, wherein the at least one optical transmitter is configured to transmit light with wavelengths greater than about 1300 nanometers.

7. The downhole optical communication system of claim 1, wherein the optical transmitter is configured to transmit light with frequencies in the range of about 1530 to about 1565 nanometers.

8. The downhole optical communication system of claim 1, wherein the optical transmitter is configured to transmit light with frequencies in the range of about 1570 to about 1610 nanometers.

9. The downhole optical communication system of claim 1, wherein the optical transmitter is configured to transmit light using wavelength division multiplexing.

10. The downhole optical communication system of claim 1, further comprising at least one optical fiber in operable communication with at least one of the at least one optical transmitter and the at least one optical receiver.

11. The downhole optical communication system of claim 1, wherein the at least one optical receiver comprises at least one photo diode.

12. The downhole optical communication system of claim 1, further comprising at least one wireline in operable communication with at least one of the at least one optical transmitter and the at least one optical receiver.

13. The downhole optical communication system of claim 1, wherein a dimension between the at least one optical transmitter and the at least one optical receiver varies.

14. The downhole optical communication system of claim 1, wherein the at least one optical transmitter and the at least one optical receiver are connected to a downhole member.

15. The downhole optical communication system of claim 1, wherein at least one of the at least one optical transmitter and the at least one optical receiver further comprises an optical amplifier.

16. A downhole optical communication system, comprising:
at least one light producing transducer; and
at least one light receiving transducer in operable communication with the at least one light producing transducer such that wellbore fluid is passable between the at least one light producing transducer and the at least one light receiving transducer, the at least one light receiving transducer being receptive of light emitted from the at least one light producing transducer and information encoded therein.

17. A downhole optical communication system, comprising:
at least one first optical transceiver; and
at least one second optical transceiver in operable communication with the at least one first optical transceiver such that wellbore fluid is passable between the at least one first optical transceiver and the at least one second optical transceiver, the at least one first optical transceiver being receptive of light emitted from the at least one second optical transceiver and information encoded therein, and the at least one second optical transceiver being receptive of light emitted from the at least one first optical transceiver and information encoded therein.

18. A downhole communication method, comprising:
transmitting optical signals having communication information encoded therein; and
receiving the optical signals and communication information encoded therein from the transmitting, the receiving being displaced from the transmitting by a dimension fillable with downhole fluid.

19. The method of claim 18, further comprising conveying the optical signals having the communication information over fiber optic cable.

20. The method of claim 18, further comprising producing the optical signals from electrical signals.

21. The method of claim 18, further comprising converting the optical signals into electrical signals.

22. The method of claim 21, further comprising conveying the communication information in the electrical signals over electrical lines.

23. The method of claim 18, further comprising varying a dimension between the transmitting and the receiving.

24. The method of claim 18, wherein the transmitting and receiving are bi-directional.
